(19) United States
(12) Patent Application Publication
(10) Pub. No.: US 2007/0226671 A1
(43) Pub. Date: Sep. 27, 2007

(54) Apparatus and method of static timing analysis considering the within-die and die-to-die process variation

(76) Inventor: Akio Hirata, Kyoto (JP)

Correspondence Address: MCDERMOTT WILL & EMERY LLP, 600 13TH STREET, NW, WASHINGTON, DC, 20005-3096, US

(21) Appl. No.: 11/723,580

(22) Filed: Mar. 21, 2007

(30) Foreign Application Priority Data
Mar. 23, 2006 (JP) 2006-081419

(51) Int. Cl. G06F 17/50

(52) U.S. Cl. 716/6

(57) ABSTRACT

In a method and apparatus for designing semiconductor integrated circuit, a path delay information producing section produces path delay information by performing a static timing analysis based on delay information of a cell and subject circuit information. A correction table producing section calculates circuit-dependent delay variation for each combination of circuit parameter values based on variation information of an element, and stores the calculated circuit-dependent delay variation in a delay correction table. A statistical path delay producing section calculates the circuit parameters for a path based on the subject circuit information and the path delay information, obtains the corresponding circuit-dependent delay variation based on the circuit-dependent delay variation correction table, and calculates and outputs statistical path delay information based on the circuit-dependent delay variation and the corresponding path delay information. Thus, it is possible to obtain a value close to an actual path delay worst value with only a little addition of calculation time.

### CROSS REFERENCE TO RELATED APPLICATION

This Non-provisional application claims priority under 35 U.S.C. §119(a) on Patent Application No. 2006-081419 filed in Japan on Mar. 23, 2006, the entire contents of which are hereby incorporated by reference.

### BACKGROUND OF THE INVENTION

The present invention relates to a method and apparatus for designing a semiconductor in which manufacturing variations are taken into consideration and which is capable of realizing a high performance and a high yield.

As the process rules for manufacturing semiconductor devices decrease, the increase in manufacturing variation has been a problem that needs to be addressed. In designing a logic of a semiconductor integrated circuit, a synchronization circuit design method is mainly used in which a process is performed within a predetermined period of time by using a clock signal. In the synchronization circuit design method,

T>Tpath+skew+setup expression 1

needs to be satisfied, where the cycle time of the clock signal is T=1/f (f is the frequency). In the expression, “Tpath” is the sum of propagation delay times through combined logic circuits present along a signal path between registers (hereinafter referred to as the “path delay”), “skew” is the difference between the arrival time of the clock signal applied to the signal sending register and that of the clock signal applied to the signal receiving register (referred to as the “clock skew”), and “setup” is the setup time of a register of a flip flop, a latch, etc.

In designing a semiconductor integrated circuit, it is necessary that Expression 1 above is satisfied for all signal paths. With a small-scale semiconductor integrated circuit, the path delay can be calculated through a circuit simulation taking into consideration the characteristics of the transistors, resistors and capacitors of the circuit.

However, with a large-scale semiconductor integrated circuit, such a circuit simulation is not possible due to the large number of elements.

In view of this, a database (referred to as a “library”) is prepared in advance, storing the characteristics of each of the logic elements called “cells” forming an integrated circuit, such as the propagation delay time from the input terminal to the output terminal, the voltage waveform transition time at the output terminal, the power consumption, etc., which are calculated in circuit simulations. Typically, the path delay time of a large-scale integrated circuit is calculated through simple calculations such as the addition, MAX operation and MIN operation while referring to the library. Such a method is called a “static timing analysis (STA)”.

Referring to FIG. 7, a path delay calculation method based on a conventional static timing analysis will be described. A static timing analysis section 203 receives cell delay information 201 and information 202 of the circuit being designed (hereinafter referred to as the “subject circuit information”). For each signal path included in the received subject circuit information 202, the static timing analysis section 203 obtains and outputs path delay information 204 by using the addition, MAX operation and MIN operation while referring to the characteristics of the cell, such as the propagation delay time, the voltage waveform transition time at the output terminal and the power consumption, included in the cell delay information 201.

However, such a static timing analysis method is known to give an excessive estimate value with respect to the path delay worst value of an actually manufactured circuit due to the recent increase in manufacturing variation. One reason is that local variation of transistors, which was very small before, has become non-negligible. For example, in the static timing analysis, the delay time is calculated to be identical for cells of an identical configuration provided along a signal path with the same input and output load conditions. However, the delay times may actually be different from one another if there is an increased transistor local variation. As a result, the static timing analysis result obtained by the results of a simulation using the transistor characteristics of the worst value no longer coincides with the actual path delay worst value.

Path delay variation is dependent not only on transistor variation, but also on variation in the wire capacitance or resistance. It is very important to estimate the path delay worst value by appropriately modeling the correlation between different types of variation and the range of path delay variation, which varies depending on the circuit configuration of the path.

In order to address the issue, a method has recently been proposed in the art in which logic element variation and path delay variation are treated statistically. This is called the “statistical static timing analysis (SSTA)”.

Non-Patent Document 1 (C. Visweswariah, et al., “First-order incremental block-based statistical timing analysis,” Design Automation Conference (DAC), pages 331-336, June 2004) proposes a method in which the delay time and variation thereof are defined by way of a linear expression. With this method, it is possible to calculate the path delay variation according to how the logic elements together forming a signal path are connected together, whereby it is possible to eliminate an excessive margin.

Patent Document 1 (Japanese Laid-Open Patent Publication No. 2002-110489) discloses a method in which a simulation is done while taking into consideration fluctuation in the circuit characteristics due to fluctuation in the manufacturing process. Patent Document 2 (Japanese Laid-Open Patent Publication No. 2002-305253) discloses a method in which the saturation current worst value is determined while taking into consideration the difference between the gate length variation among pMOS transistors and that among NMOS transistors.

Thus, unlike the conventional static timing analysis methods, conventional statistical static timing analysis methods can avoid giving an excessive estimate value with respect to the path delay worst value of an actually manufactured circuit. However, they still have problems as follows.

For example, with the statistical static timing analysis method as shown in Non-Patent Document 1, it is difficult to precisely calculate/express the range of delay variation for the cells, and it is therefore difficult to increase the precision with which the path delay variation is calculated. Another problem is the increase in the calculation time as compared with conventional static timing analysis methods. The method disclosed in Patent Document 1 also has the problem of increased calculation time.

The method disclosed in Patent Document 2 fails to take into consideration changes in the range of path delay variation depending on the circuit configuration of the path. Therefore, it is difficult to increase the precision with the method.

Moreover, it is not possible to determine the difference between a worst delay value calculated by the statistical static timing analysis method of Non-Patent Document 1 and that calculated by a conventional static timing analysis method. Therefore, it is difficult for a designer to grasp the influence of the circuit dependency of the range of path delay variation due to process variation or to check whether or not there is erroneous input information.

### SUMMARY OF THE INVENTION

It is therefore an object of the present invention to provide an apparatus and method for designing a semiconductor integrated circuit capable of quickly and precisely calculating fluctuation in the path delay time due to fluctuation in the semiconductor device manufacturing process.

It is also an object of the present invention to provide an apparatus and method for designing a semiconductor integrated circuit capable of quickly and precisely calculating a path delay worst value while appropriately taking into consideration how the range of path delay variation changes depending on the circuit configuration of the path.

In order to achieve the object set forth above, the apparatus and method for designing a semiconductor integrated circuit of the present invention uses a correction value table prepared in advance or an analysis formula with which a correction value can be uniquely calculated, instead of calculating delay variation for each logic element along a signal path, wherein path delay information produced by a conventional static timing analysis method is multiplied by a correction value obtained from the correction value table or the analysis formula, thus realizing a statistical timing analysis.

Specifically, an apparatus for designing a semiconductor integrated circuit of the present invention includes: a path delay information producing section for producing path delay information based on delay information of a cell and subject circuit information; a correction table producing section for receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters; and a statistical path delay producing section for calculating each of the group of circuit parameters for a path included in the path delay information produced by the delay information producing section based on the subject circuit information and the path delay information, obtaining a delay correction value for each of the calculated group of circuit parameters with reference to the circuit-dependent delay variation correction table produced by the correction table producing section, and calculating and outputting statistical path delay information based on the obtained delay correction value and the path delay information.

In one embodiment of the apparatus for designing a semiconductor integrated circuit of the present invention, one of the group of circuit parameters is calculated based on a rising transition time and a falling transition time of at least each node along the path.

In one embodiment of the apparatus for designing a semiconductor integrated circuit of the present invention, one of the group of circuit parameters is a ratio Kt between a sum of rising transition times of nodes along the path and a sum of falling transition times of the nodes along the path.

In one embodiment of the apparatus for designing a semiconductor integrated circuit of the present invention, one of the group of circuit parameters is calculated based on a wire capacitance for each node along the path and a MOSFET gate capacitance for each node along the path.

In one embodiment of the apparatus for designing a semiconductor integrated circuit of the present invention, one of the group of circuit parameters is a ratio Kw between a sum of wire capacitances for the nodes along the path and a sum of MOSFET gate capacitances for the nodes along the path.

In one embodiment of the apparatus for designing a semiconductor integrated circuit of the present invention, one of the group of circuit parameters is the number of cell logic stages Ld along the path.

In one embodiment of the apparatus for designing a semiconductor integrated circuit of the present invention, one of the group of circuit parameters is the number of paths for which a delay value is within a predetermined range.

In one embodiment of the apparatus for designing a semiconductor integrated circuit of the present invention, one of the device variation information is variation information of transistor saturation current value.

In one embodiment of the apparatus for designing a semiconductor integrated circuit of the present invention, the device variation information of the transistor saturation current value includes a median value Idsn_TYP and a standard deviation σ_IN of a saturation current value of an N-type MOS transistor, a median value Idsp_TYP and a standard deviation σ_IP of a saturation current value of a P-type MOS transistor, and a correlation coefficient R_PN between the saturation current value of the N-type MOS transistor and the saturation current value of the P-type MOS transistor.

In one embodiment of the apparatus for designing a semiconductor integrated circuit of the present invention, one of the device variation information is variation information of a capacitance value of a gate terminal of a transistor.

In one embodiment of the apparatus for designing a semiconductor integrated circuit of the present invention, one of the device variation information is variation information of a capacitance value of a source or drain terminal of a transistor.

In one embodiment of the apparatus for designing a semiconductor integrated circuit of the present invention, one of the device variation information is variation information of a capacitance value of an element other than a transistor.

In one embodiment of the apparatus for designing a semiconductor integrated circuit of the present invention, the device variation information of the capacitance value of an element other than a transistor is a value derived from variation in a thickness, width or height of a metal wire.

In one embodiment of the apparatus for designing a semiconductor integrated circuit of the present invention, the correction table producing section calculates the delay correction value depending on the circuit parameter by using an analysis formula representing a relationship between the circuit parameter and the delay correction value.

In one embodiment of the apparatus for designing a semiconductor integrated circuit of the present invention, the correction table producing section calculates: a variable idsp dependent on Idsp_TYP and σ_IP; a variation variable idsn dependent on Idsn_TYP, σ_IN, R_PN and the variable idsp; variables cg1 and cg2 dependent on a capacitance variation of a gate, a source of a drain of the transistor; and a path delay Tpd dependent on the variables cw1 and cw2 dependent on variation information of a capacitor other than the transistor.

In one embodiment of the apparatus for designing a semiconductor integrated circuit of the present invention, the path delay Tpd is also dependent on the ratio Kt and the ratio Kw, and is defined by an expression including the following expression:

Kt(cg1+Kw·cw1)/idsp+(cg2+Kw·cw2)/idsn, or

(cg1+Kw·cw1)/idsp+Kt(cg2+Kw·cw2)/idsn, or

Kt(Kw·cg1+cw1/idsp+(Kw·cg2+cw2)/idsn, or

(Kw·cg1+cw1)/idsp+Kt(Kw·cg2+cw2)/idsn.

In one embodiment of the apparatus for designing a semiconductor integrated circuit of the present invention, a ratio Tpd_worst1/Tpd_worst2 is produced as a value of the table at least for each combination of values of the circuit parameters Kt and Kw, wherein Tpd_worst1 is obtained by multiplying a standard deviation of the path delay Tpd by a first constant value and adding a median value of the path delay Tpd to the product, and Tpd_worst2 is a value obtained by substituting the variables cg1, cw1, idsp, cg2, cw2 and idsn in the path delay expression with second to seventh constant values, respectively.

In one embodiment of the apparatus for designing a semiconductor integrated circuit of the present invention, the cell delay information includes at least one of a transition time of an internal node of each cell and a wire capacitance and gate capacitance of an internal node of each cell.

In one embodiment of the apparatus for designing a semiconductor integrated circuit of the present invention, a transition time of an internal node of each cell is calculated based on an input waveform transition time, an output waveform transition time and a propagation delay time added to the cell.

In one embodiment of the apparatus for designing a semiconductor integrated circuit of the present invention, a wire capacitance and a gate capacitance of an internal node of each cell are calculated based on a size of an output transistor of the cell.

In one embodiment of the apparatus for designing a semiconductor integrated circuit of the present invention, a subject circuit is modified so that at least one of Kw, Kt and Ld is changed in such a manner that the calculated statistical path delay information is within a predetermined range.

In one embodiment of the apparatus for designing a semiconductor integrated circuit of the present invention, a change in at least one of Kw and Kt is made by changing a size of a transistor included in the path.

In one embodiment of the apparatus for designing a semiconductor integrated circuit of the present invention, a change in at least one of Kw and Kt is made by inserting a third logic element between a first logic element present along the path and a second logic element whose input is connected to an output of the first logic element.

In one embodiment of the apparatus for designing a semiconductor integrated circuit of the present invention, the third logic element is a buffer circuit or an inverter circuit.

An apparatus for designing a semiconductor integrated circuit of the present invention includes: a transition time ratio calculating section for calculating a ratio Kt between a sum of rising transition times of nodes along a first path and a sum of falling transition times of the nodes along the first path, based on subject circuit information and path delay information; a capacitance ratio calculating section for calculating a ratio Kw between a sum of wire capacitances for the nodes along the first path and a sum of MOSFET gate capacitances for the nodes along the first path, based on the subject circuit information and the path delay information; and a statistical path delay information calculating section for calculating and outputting statistical path delay information dependent on the delay time of the first path included in the path delay information and at least one of Kt and Kw.

A method for designing a semiconductor integrated circuit of the present invention includes: a path delay information producing step of producing path delay information based on delay information of a cell and subject circuit information; a correction table producing step of receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters; and a statistical path delay producing step of calculating each of the group of circuit parameters for a path included in the path delay information produced in the delay information producing step based on the subject circuit information and the path delay information, obtaining a delay correction value for each of the calculated group of circuit parameters with reference to the circuit-dependent delay variation correction table produced in the correction table producing step, and calculating and outputting statistical path delay information based on the obtained delay correction value and the path delay information.

In one embodiment of the method for designing a semiconductor integrated circuit of the present invention, one of the group of circuit parameters is calculated based on a rising transition time and a falling transition time of at least each node along the path.

In one embodiment of the method for designing a semiconductor integrated circuit of the present invention, one of the group of circuit parameters is a ratio Kt between a sum of rising transition times of nodes along the path and a sum of falling transition times of the nodes along the path.

In one embodiment of the method for designing a semiconductor integrated circuit of the present invention, one of the group of circuit parameters is calculated based on a wire capacitance for each node along the path and a MOSFET gate capacitance for each node along the path.

In one embodiment of the method for designing a semiconductor integrated circuit of the present invention, one of the group of circuit parameters is a ratio Kw between a sum of wire capacitances for the nodes along the path and a sum of MOSFET gate capacitances for the nodes along the path.

In one embodiment of the method for designing a semiconductor integrated circuit of the present invention, one of the group of circuit parameters is the number of cell logic stages Ld along the path.

In one embodiment of the method for designing a semiconductor integrated circuit of the present invention, one of the group of circuit parameters is the number of paths for which a delay value is within a predetermined range.

In one embodiment of the method for designing a semiconductor integrated circuit of the present invention, one of the device variation information is variation information of transistor saturation current value.

In one embodiment of the method for designing a semiconductor integrated circuit of the present invention, the device variation information of the transistor saturation current value includes a median value Idsn_TYP and a standard deviation σ_IN of a saturation current value of an N-type MOS transistor, a median value Idsp_TYP and a standard deviation σ_IP of a saturation current value of a P-type MOS transistor, and a correlation coefficient R_PN between the saturation current value of the N-type MOS transistor and the saturation current value of the P-type MOS transistor.

In one embodiment of the method for designing a semiconductor integrated circuit of the present invention, one of the device variation information is variation information of a capacitance value of a gate terminal of a transistor.

In one embodiment of the method for designing a semiconductor integrated circuit of the present invention, one of the device variation information is variation information of a capacitance value of a source or drain terminal of a transistor.

In one embodiment of the method for designing a semiconductor integrated circuit of the present invention, one of the device variation information is variation information of a capacitance value of an element other than a transistor.

In one embodiment of the method for designing a semiconductor integrated circuit of the present invention, the device variation information of the capacitance value of an element other than a transistor is a value derived from variation in a thickness, width or height of a metal wire.

In one embodiment of the method for designing a semiconductor integrated circuit of the present invention, the correction table producing step calculates the delay correction value depending on the circuit parameter by using an analysis formula representing a relationship between the circuit parameter and the delay correction value.

In one embodiment of the method for designing a semiconductor integrated circuit of the present invention, the correction table producing step calculates: a variable idsp dependent on Idsp_TYP and σ_IP; a variation variable idsn dependent on Idsn_TYP, σ_IN, R_PN and the variable idsp; variables cg1 and cg2 dependent on a capacitance variation of a gate, a source of a drain of the transistor; and a path delay Tpd dependent on the variables cw1 and cw2 dependent on variation information of a capacitor other than the transistor.

In one embodiment of the method for designing a semiconductor integrated circuit of the present invention, the path delay Tpd is also dependent on the ratio Kt and the ratio Kw, and is defined by an expression including the following expression:

Kt(cg1+Kw·cw1)/idsp+(cg2+Kw·cw2)/idsn, or

(cg1+Kw·cw1)/idsp+Kt(cg2+Kw·cw2)/idsn, or

Kt(Kw·cg1+cw1)/idsp+(Kw·cg2+cw2)/idsn, or

(Kw·cg1+cw1)/idsp+Kt(Kw·cg2+cw2)/idsn.

In one embodiment of the method for designing a semiconductor integrated circuit of the present invention, a ratio Tpd_worst1/Tpd_worst2 is produced as a value of the table at least for each combination of values of the circuit parameters Kt and Kw, wherein Tpd_worst1 is obtained by multiplying a standard deviation of the path delay Tpd by a first constant value and adding a median value of the path delay Tpd to the product, and Tpd_worst2 is a value obtained by substituting the variables cg, cw1, idsp, cg2, cw2 and idsn in the path delay expression with second to seventh constant values, respectively.

In one embodiment of the method for designing a semiconductor integrated circuit of the present invention, the cell delay information includes at least one of a transition time of an internal node of each cell and a wire capacitance and gate capacitance of an internal node of each cell.

In one embodiment of the method for designing a semiconductor integrated circuit of the present invention, a transition time of an internal node of each cell is calculated based on an input waveform transition time, an output waveform transition time and a propagation delay time added to the cell.

In one embodiment of the method for designing a semiconductor integrated circuit of the present invention, a wire capacitance and a gate capacitance of an internal node of each cell are calculated based on a size of an output transistor of the cell.

In one embodiment of the method for designing a semiconductor integrated circuit of the present invention, a subject circuit is modified so that at least one of Kw, Kt and Ld is changed in such a manner that the calculated statistical path delay information is within a predetermined range.

In one embodiment of the method for designing a semiconductor integrated circuit of the present invention, a change in at least one of Kw and Kt is made by changing a size of a transistor included in the path.

In one embodiment of the method for designing a semiconductor integrated circuit of the present invention, a change in at least one of Kw and Kt is made by inserting a third logic element between a first logic element present along the path and a second logic element whose input is connected to an output of the first logic element.

In one embodiment of the method for designing a semiconductor integrated circuit of the present invention, the third logic element is a buffer circuit or an inverter circuit.

A method for designing a semiconductor integrated circuit of the present invention includes: a transition time ratio calculating step of calculating a ratio Kt between a sum of rising transition times of nodes along a first path and a sum of falling transition times of the nodes along the first path, based on subject circuit information and path delay information; a capacitance ratio calculating step of calculating a ratio Kw between a sum of wire capacitances for the nodes along the first path and a sum of MOSFET gate capacitances for the nodes along the first path, based on the subject circuit information and the path delay information; and a statistical path delay information calculating step of calculating and outputting statistical path delay information dependent on the delay time of the first path included in the path delay information and at least one of Kt and Kw.

A method for designing a semiconductor integrated circuit of the present invention includes: a path delay information producing step of producing path delay information based on delay information of a cell and subject circuit information; a correction table producing step of receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters; a statistical path delay producing step of calculating each of the group of circuit parameters for a path included in the path delay information produced in the delay information producing step based on the subject circuit information and the path delay information, obtaining a delay correction value for each of the calculated group of circuit parameters with reference to the circuit-dependent delay variation correction table produced in the correction table producing step, and calculating and outputting statistical path delay information based on the obtained delay correction value and the path delay information; and an output step of producing a value or a graph based on the statistical path delay information and the path delay information to output the produced value or graph to an output device.

In one embodiment of the method for designing a semiconductor integrated circuit of the present invention, the value or graph produced in the output step based on the statistical path delay information and the path delay information includes a first graph obtained by processing the path delay information and a second graph obtained by processing the statistical path delay information.

In one embodiment of the method for designing a semiconductor integrated circuit of the present invention, in the output step, one of the first graph and the second graph is selectively output at a time to the output device according to an input from an input device.

In one embodiment of the method for designing a semiconductor integrated circuit of the present invention, the output step produces a third graph including at least one of information obtained by processing at least the path delay information and information obtained by processing at least the statistical path delay information to output the third graph to the output device.

In one embodiment of the method for designing a semiconductor integrated circuit of the present invention, the third graph produced in the output step further includes information obtained by processing Kt, Kw or Ld.

In one embodiment of the method for designing a semiconductor integrated circuit of the present invention, the first or second graph is a histogram.

In one embodiment of the method for designing a semiconductor integrated circuit of the present invention, the first or second graph is a scatter diagram.

According to the present invention, where a statistical static timing analysis for estimating a value close to an actual path delay worst value is performed, path delay information is produced by using a commonly-employed static timing analysis method, and the path delay information is multiplied by a variation correction value obtained from a correction table prepared in advance or a predetermined analysis formula to thereby obtain statistical path delay information. Therefore, as compared with a conventional statistical static timing analysis method, it is no longer necessary to calculate the range of variation for each logic element, whereby it is possible to shorten the amount of time required for the calculation.

According to the present invention, it is possible to give an appropriate consideration to how the range of path delay variation changes depending on the circuit configuration of the path, whereby it is possible to quickly and precisely calculate the path delay worst value.

According to the present invention, the path circuit can be modified based on the path delay worst value, which is quickly and precisely calculated, whereby it is possible to improve the yield of a semiconductor integrated circuit or to reduce the power consumption and the chip area.

According to the present invention, the delay value before being corrected with variation taken into consideration and the corrected delay value can be compared with each other, whereby the user of the apparatus for designing a semiconductor integrated circuit can easily understand the difference in the delay value due to the influence of variation.

According to the present invention, the delay value before being corrected with variation taken into consideration and the corrected delay value can be compared with each other by using a graph, whereby the user of the apparatus for designing a semiconductor integrated circuit can easily understand the difference in the delay value due to the influence of variation.

According to the present invention, the delay value before being corrected with variation taken into consideration and the corrected delay value can be compared with each other while being processed into various forms of graphs, whereby the user of the apparatus for designing a semiconductor integrated circuit can easily understand the difference in the delay value due to the influence of variation.

According to the present invention, the graph is a histogram, whereby the user of the apparatus for designing a semiconductor integrated circuit can easily understand the difference in distribution between the delay value before being corrected with variation taken into consideration and the corrected delay value.

According to the present invention, the graph is a scatter diagram, whereby the user of the apparatus for designing a semiconductor integrated circuit can easily understand the degree of change in the delay value before being corrected with variation taken into consideration or the corrected delay value.

### BRIEF DESCRIPTION OF THE DRAWINGS

FIG. 1 is a block diagram showing an apparatus for designing a semiconductor integrated circuit according to a first embodiment of the present invention.

FIG. 2 shows a hardware configuration of the apparatus for designing a semiconductor integrated circuit.

FIG. 3 shows a model circuit representing delay characteristics of a path circuit.

FIG. 4 is a graph showing Kp, Kp max and the Kp correction value with respect to a circuit parameter Kw.

FIG. 5 is a block diagram showing an apparatus for designing a semiconductor integrated circuit according to a second embodiment of the present invention.

FIG. 6 is a block diagram showing an apparatus for designing a semiconductor integrated circuit according to a third embodiment of the present invention.

FIG. 7 is a block diagram showing a conventional static timing analysis apparatus.

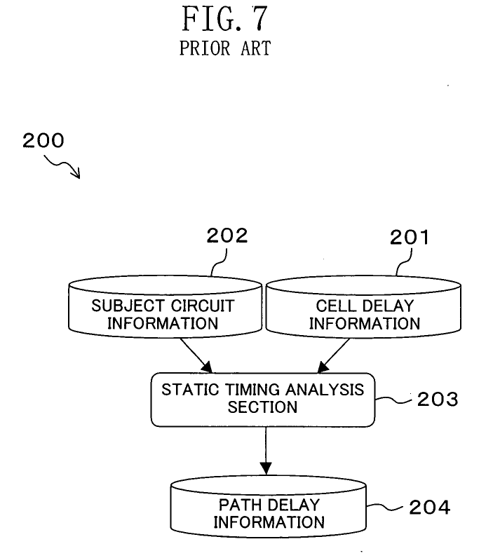

FIG. 8 shows an output device provided in the apparatus for designing a semiconductor integrated circuit according to a fourth embodiment of the present invention.

FIG. 9 shows an output device provided in the apparatus for designing a semiconductor integrated circuit according to a fifth embodiment of the present invention.

### DESCRIPTION OF THE PREFERRED EMBODIMENTS

Preferred embodiments of the present invention will now be described with reference to the drawings.

### Embodiment 1

A method and apparatus for designing a semiconductor integrated circuit according to according to a first embodiment of the present invention will now be described with reference to the drawings.

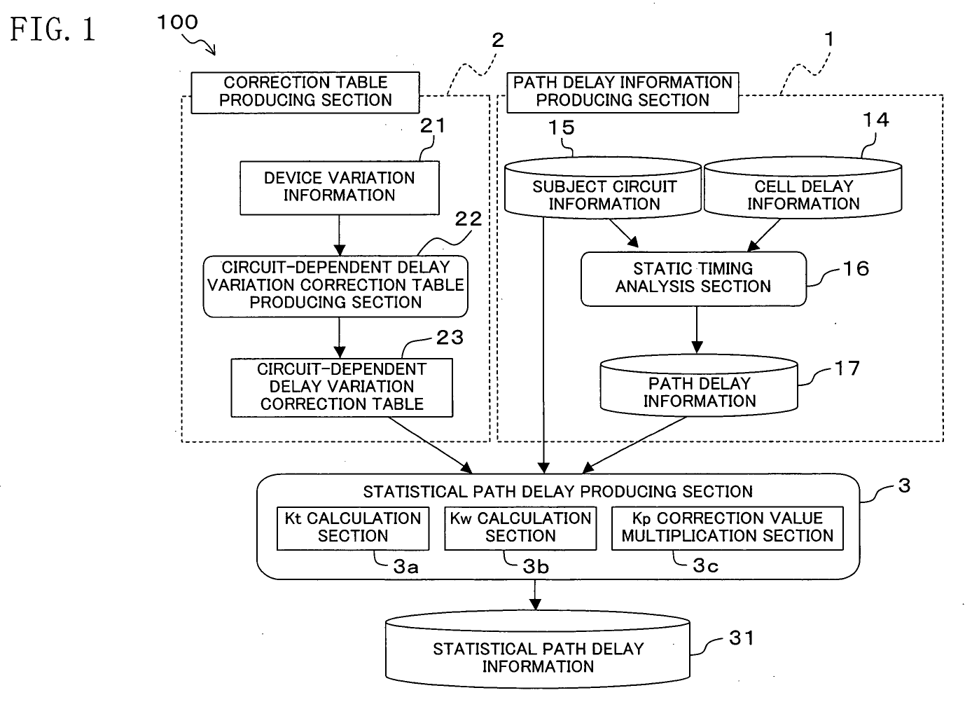

FIG. 1 is a block diagram showing an apparatus for designing a semiconductor integrated circuit of the present embodiment.

In FIG. 1, reference numeral 100 denotes a timing analysis device, 1 a path delay information producing section, 2 a correction table producing section, and 3 a statistical path delay producing section.

The path delay information producing section 1 includes a static timing analysis section 16 for producing path delay information 17 between registers, based on subject circuit information 15 and cell delay information 14, where the subject circuit information 15 represents how different cells are connected to one another and how parasitic elements, such as capacitors and resistors along wires between cells, are connected to one another, and the cell delay information 14 represents information of each cell, including the delay time between the input pin and the output pin, the output waveform transition time, the power consumption, the pin parasitic capacitance, etc. The subject circuit information 15 represents the position of each cell, how the cells are connected to one another, the position of a wire between cells, the parasitic capacitance and resistance thereof, etc..

Referring to FIG. 1, a correction table producing section 2 includes a circuit-dependent delay variation correction table producing section 22 for producing a circuit-dependent delay variation correction table 23. The circuit-dependent delay variation correction table 23 calculates, for each of the circuit parameter values representing the characteristics of the path, a value for correcting the difference between the result of the static timing analysis of path delay variation and the actual path delay worst value, based on device variation information 21 representing variations among transistors and those in the wire capacitance and resistance, etc. The calculated correction value is stored in the circuit-dependent delay variation correction table 23 while being associated with a combination of circuit parameters.

Moreover, a statistical path delay producing section 3 of FIG. 1 receives the path delay information 17, the subject circuit information 15 and the circuit-dependent variation correction table 23 to output statistical path delay information 31.

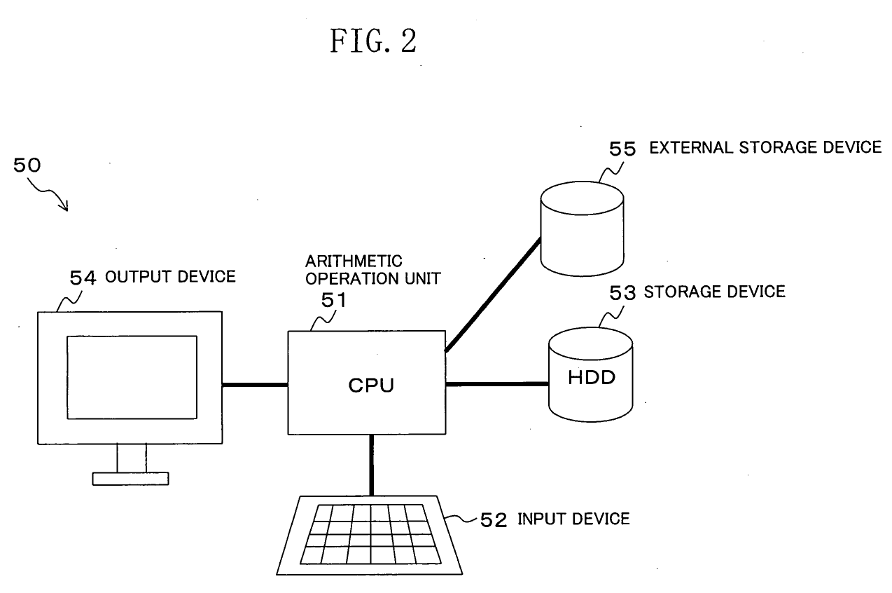

FIG. 2 shows a hardware configuration of the apparatus for designing a semiconductor integrated circuit shown in FIG. 1. An apparatus 50 for designing a semiconductor integrated circuit shown in FIG. 2 includes an arithmetic operation unit 51, an input device 52, a storage device 53, and an output device 54. The cell delay information 14, the subject circuit information 15 and the device variation information 21 are produced and stored in the storage device 53 based on information input from the input device 52 or information read out from an external storage device 55. The path delay information 17, the circuit-dependent variation correction table 23 and the statistical path delay information 31 are processed by the arithmetic operation unit 51 based on information stored in the storage device 53 and information input from the input device 52, and are stored in the storage device 53. The information stored in the storage device 53 is output from the output device 54. The storage device 53 may be a hard disk drive, a drive capable of receiving a medium such as a DVD or a CD-ROM, or a memory such as a DRAM, an SRAM or a non-volatile memory. The external storage device 55 may be a hard disk drive connected to a network, a drive connected to a network which is capable of receiving a medium such as a DVD or a CD-ROM, or a memory such as a DRAM, an SRAM or a non-volatile memory.

A configuration for correcting each path delay will now be described in detail. One reason for the path delay information obtained from a single worst corner simulation to not coincide with the worst delay value obtained where variations actually occur among elements is the above-described local element variation. Another reason is that there may be or may not be a correlation between element variations, and the influence of an element variation on the path delay varies depending on the circuit configuration.

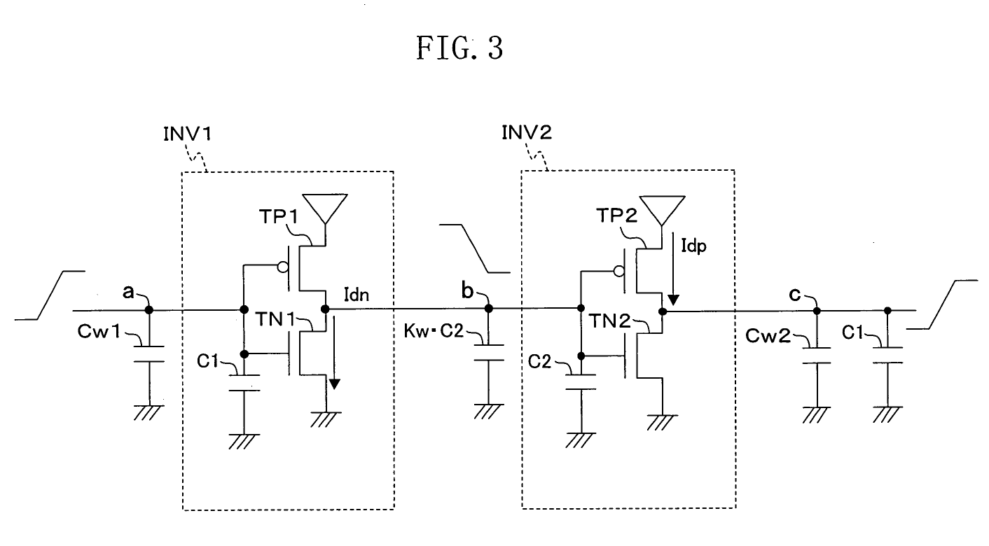

In order to produce the circuit-dependent delay variation correction table 23 in the correction table producing section 2, it was necessary to identify what influence is given by each information of the path circuit. The delay characteristics of a path circuit were analyzed while assuming a circuit shown in FIG. 3 as a model circuit including a minimum necessary configuration for representing the delay characteristics of the path circuit.

FIG. 3 shows the model circuit representing the delay characteristics of the path circuit. The illustrated model includes two inverter circuits. In the figure, TP1 and TP2 denote P-type MOS transistors, TN1 and TN2 N-type MOS transistors, a, b and c nodes, C1 the equivalent capacitor at the gate terminals of the P-type MOS transistor TP1 and the N-type MOS transistor TN1, C2 the equivalent capacitor at the gate terminals of the P-type MOS transistor TP2 and the N-type MOS transistor TN2, INV1 and INV2 inverter circuits, and Cw1 and Cw2 wire capacitors. IDN denotes the saturation current of the N-type MOS transistor TN1, and IDP the saturation current of the P-type MOS transistor TP1. Tpd denotes the propagation delay time from the node a to the node c. A CMOS circuit alternates a rising transition and a falling transition with each other. Therefore, in order to represent the path delay characteristics, it is necessary to take into consideration the delay time resulting when at least two inverter circuits are connected together.

With reference to Non-Patent Document 2 (Takayasu Sakurai and A. Richard Newton, “Alpha-Power Law MOSFET Model and its Application to CMOS Inverter Delay and Other Formulas,” IEEE Journal of Solid-state circuits, vol. 25, pages 584-594, April 1990), the propagation delay time Tpd from the node a to the node c (i.e., the amount of time from when the voltage waveform at the node a exceeds 50% of the power supply voltage until the voltage waveform at the node c exceeds 50% of the power supply voltage) is expressed as shown in the following expressions.

$$\begin{matrix}{T}_{pd} = a \frac{( C 1 + Cw 1 )}{0.7 {I}_{DP}} + \frac{( C 2 + Cw 2 )}{2 {I}_{DN}} + a \frac{( C 2 + Cw 2 )}{0.7 {I}_{DN}} + \frac{( C 1 + Cw 1 )}{2 {I}_{DP}} & expression 2 \\ a = ( \frac{1}{2} - \frac{1 - {V}_{T} / {V}_{DD}}{1 + α} ) & expression 3\end{matrix}$$

In the expressions, IDP, IDN, C1, C2, Cw1 and Cw2 are variables with normal distribution. The median values are IDP_TYP, IDN_TYP, C1_TYP, C2_TYP, Kw×C1_TYP and Kw×C2_TYP, respectively. Where σIDP, σIDN, σC1, σC2, σCw and σCw denote their ratios with respect to the median values of standard deviation, IDP, IDN, C1, C2, Cw1 and Cw2 are expressed as shown in the following expressions.

I_{DP}=I_{DP}_{_{—}}_{TYP}·i_{DP}=I_{DP}_{_{—}}_{TYP}(1+σ_{IDP}X_{IDP}) expression 4

I_{DN}·=I_{DN}_{_{—}}_{TYP}·i_{DN}=I_{DN}_{_{—}}_{TYP}(1+σ_{IDN}X_{IDN}) expression 5

C1=C1_{TYP}·c1=C1_{TYP}(1+σ_{C1}X_{C1}) expression 6

C2=C2_{TYP}·c2=C2_{TYP}(1+σ_{C2}X_{C2}) expression 7

Cw1=K_{W}·C1_{TYP}·cw=K_{W}·C1_{TYP}·(1+σ_{Cw}X_{Cw}) expression 8

Cw2=K_{W}·C2_{TYP}·cw=K_{W}C2_{TYP}·(1+σ_{Cw}X_{Cw}) expression 9

In the expressions, iDP, iDN, c1, c2 and cw are variables whose median value is 1 and whose standard deviations are σIDP, σIDN, σC1, σC2, σCw and σCw, respectively. Tpd is expressed as shown in the following expression.

$$\begin{matrix}{T}_{pd} = ( a / 0.7 + 0.5 ) \frac{C {2}_{TYP} {V}_{DD}}{{I}_{DN\_TYP}} \{ {K}_{T} \cdot \frac{c 1 + Kw \cdot cw}{{i}_{DP}} + \frac{c 2 + Kw \cdot cw}{{i}_{DN}} \} \\ where & expression 10 \\ {K}_{T} = \frac{C {1}_{TYP}}{{I}_{DP\_TYP}} / \frac{C {2}_{TYP}}{{I}_{DN\_TYP}} & expression 11\end{matrix}$$

Kp, which herein denotes the ratio between the worst value of the delay time Tpd (herein assumed to be “median value of Tpd+3×standard deviation of Tpd”) and the median value of the delay time Tpd, is expressed as shown in the following expression.

$$Kp = [ 1 + 3 \times σ \{ {K}_{T} \frac{c 1 + Kw \cdot cw}{{i}_{DP}} + \frac{c 2 + Kw \cdot cw}{{i}_{DN}} \} ] / \{ ( 1 + {K}_{T} ) ( 1 + Kw ) \} \qquad expression 12$$

where σ{ } is a function representing the standard deviation of what is inside the braces.

The worst corner values of the variables iDP, iDN, c1, c2 and cw (herein assumed to be “median value−3×standard deviation” for iDP and iDN, and “median value+3×standard deviation” for c1, c2 and cw) are denoted as iDPss, iDNss, c1ss, c2ss and cwss, respectively. Kp_max, which herein denotes the ratio between the delay time Tpd when using the worst corner value as defined above and the median value of the delay time Tpd, is expressed as shown in the following expression.

$$Kp\_max = \{ {K}_{T} \frac{c 1 ss + Kw \cdot cwss}{{i}_{DPss}} + \frac{c 2 ss + Kw \cdot cwss}{{i}_{DNss}} \} / \{ ( 1 + {K}_{T} ) ( 1 + Kw ) \} \qquad expression 13$$

where Kp is the ratio between the median value and the worst value obtained when the inverter circuit of FIG. 3 is actually manufactured or the worst value obtained in a Monte Carlo simulation with manufacturing variation taken into consideration. Kp_max is equivalent to the ratio between the worst value and the median value obtained in a conventional simulation using the worst corner parameter.

Where iDP is in complete correlation with iDN (correlation coefficient R=1) and iDP and iDN are in complete negative correlation with c1, c2 and cw (correlation coefficient R=−1), Kp and Kp_max are of the same value. However, when the correlation coefficient of iDP, iDN, c1, c2 and cw is greater than −1 and less than 1, Kp and Kp_max are of different values. It never happens in an actual manufacturing process that iDP and iDN are in complete correlation with each other while iDP and iDN are in complete negative correlation with c1, c2 and cw. Thus, the worst value of the delay time obtained in a conventional simulation using the worst corner parameter is different from the worst value in an actual manufacturing process. The relationship between Kp and Kp_max is dependent on the values of the circuit parameters KT and Kw. The ratio between Kp and Kp_max is defined herein as the Kp correction value.

Kp correction value=Kp/Kp_max expression 14

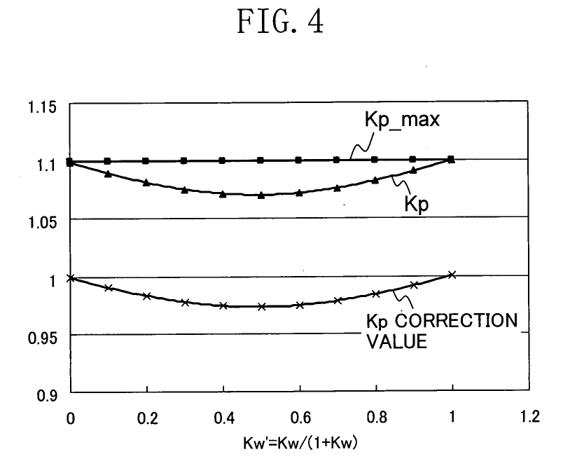

This will be discussed below with reference to FIG. 4. FIG. 4 is a graph showing Kp, Kp_max and the Kp correction value with respect to the circuit parameter Kw. For the sake of simplicity, iDP and iDN are fixed to 1, c1 and c2 are in complete correlation with each other, and c1 and c2 have zero correlation with cw. The median value of c1, c2 and cw is 1, the standard deviation thereof is 0.1/3. Then, c1ss, c2ss and cwss are 1.1.

The horizontal axis of the graph is Kw′=Kw/(1+Kw). Kw=Kw′/(1−Kw′).

The value of Kp_max is constant irrespective of the value of the circuit parameter Kw. This is because c1ss, c2ss and cwss are of the same value. When they are of different values, Kp_max is a linear function of Kw′. Kp takes the maximum value when Kw′ is 0 or 1, and takes the minimum value when Kw′ is 0.5. The Kp correction value, being the ratio between Kp and Kp_max, is 1 when Kw′ is 0 or 1, and takes the minimum value when Kw′ is 0.5.

Thus, the Kp correction value changes as the circuit parameter, which is dependent on the circuit being designed, changes. This means that the ratio between the worst value in an actual manufacturing process and the worst value obtained in a simulation using the worst corner parameter changes depending on the circuit being designed. How the Kp correction value changes can be calculated based on Expressions 12, 13 and 14.

The circuit parameter Kt, as shown in Expression 11, includes the transistor saturation currents IDP_TYP and IDN_TYP. Where Trise denotes the rising transition time of the voltage waveform at the node c, and Tfall denotes the falling transition time of the waveform at the node b, they are approximately expressed as follows: Trise∝C1_TYP/IDP_TYP and Tfall∝C2_TYP/IDN_TYP based on Non-Patent Document 2. Thus, the circuit parameter Kt can be approximately calculated as follows.

K_{T}=Tᵣᵢₛₑ/T_{fall} expression 15

In a positive logic cell, such as an AND circuit (=a cascade connection of an NAND circuit and an inverter circuit) or a buffer circuit (=a cascade connection of two or an even number of inverter circuits), the output is a rising transition if the input is a rising transition. At an internal node (=where the NAND circuit and the inverter circuit are connected together in an AND circuit), a falling transition occurs. It is possible to realize an even more precise calculation by including the transition time information of the internal node in the cell delay information 14. Alternatively, the value can be calculated by a polynominal approximation based on the input waveform transition time of the cell, the output waveform transition time thereof, the delay time from the input pin to the output pin, etc.

Next, the ratio Kp_total between the worst value and the median value of the path delay in a manufacturing process where the in-chip local manufacturing variation is taken into consideration is calculated by the following expression.

$$Kp\_total = 1 + \sqrt{{( Kp - 1 )}^{2} + {K}_{c}^{2} \frac{{\sum }_{i} ( {Tpd}_{i}^{2} )}{{( {\sum }_{i} {Tpd}_{i} )}^{2}}} \qquad expression 16$$

Kp is the value calculated by Expression 12, Tpdi is the median value of the delay time of logic elements along the path, Kc is the ratio of the delay time variation (e.g., 3×standard deviation) per logic element due to local manufacturing variation with respect to the median value.

Kp_max_total, representing the ratio between the worst value obtained in a simulation using the worst corner parameter and the median value is calculated by the following expression.

Kp_max_total=1+\sqrt{(Kp_max−1)²+K_{c}²} expression 17

Kp_max is the value calculated by Expression 13.

The Kp correction value, where the local manufacturing variation is taken into consideration, can be calculated by Kp_max_total/Kp_total.

Thus, with the apparatus for designing a semiconductor integrated circuit of the present embodiment shown in FIG. 1, it is possible to calculate the path delay value equal to the worst value in an actual manufacturing process.

Specifically, the correction table producing section 2 calculates, in advance, Kp, Kp_max and the Kp correction value (the delay correction value) (the ratio between the worst value in an actual manufacturing process and the worst value obtained in an simulation using the worst corner parameter) according to the circuit parameters Kw and KT, which change depending on the circuit being designed, based on Expressions 12, 13 and 14, and produces the circuit-dependent delay variation correction table 23 where the calculated values are associated with the circuit parameters.

The path delay information producing section 1 produces the path delay information 17 calculated by a static timing analysis from the cell delay information 14 produced based on a transistor model 1 using the worst corner parameter.

As shown in FIG. 1, the statistical path delay producing section 3 includes a Kt calculation section (transition time ratio calculation section) 3a for calculating Kt, which is the sum of rising transition times along the path/the sum of falling transition times along the path, based on the path delay information 17 and the subject circuit information 15, and a Kw calculation section (capacitance ratio calculation section) 3b for calculating the circuit parameter Kw, which is the sum of the wire capacitances for the nodes along the path/the sum of the MOSFET gate capacitances for the nodes along the path. Based on the calculated circuit parameters Kt and Kw for the path, Kp and Kp_max are obtained with reference to the circuit-dependent variation correction table 23, and the Kp correction value, where the local manufacturing variation is taken into consideration, is calculated from Kp_max_total/Kp_total based on Expressions 16 and 17. A Kp correction value multiplication section (statistical path delay information calculating section) 3c multiplies the calculated Kp correction value by the path delay information 17 to output the statistical path delay information 31.

As described above, according to the present embodiment, in contrast to the conventional static timing analysis method, it is possible to obtain a value close to the path delay worst value in an actual manufacturing process.

Since the present embodiment uses a static timing analysis method, which is commonly employed in producing the path delay information, it is not necessary to calculate the range of variation for each logic element, which is necessary with the conventional statistical static timing analysis method. The present embodiment obtains the variation correction value with reference to the correction table prepared in advance, and the correction value is multiplied by the path delay obtained by a static timing analysis, thereby calculating the statistical path delay information. Thus, it is possible to shorten the amount of time required for the calculation.

In the present embodiment, Kp, Kp_max and the Kp correction value are calculated in advance in the correction table producing section 2 in order to shorten the amount of time required for calculation in the statistical path delay producing section 3. Alternatively, these values may be calculated as necessary in the statistical path delay producing section 3 based on the values of the circuit parameters Kt and Kw. In such a case, the Kp correction value may be calculated only when the proportion of the right side of Expression 1 (Tpath+skew+setup) to the cycle time T exceeds a predetermined proportion, thus shortening the amount of time required for calculation.

While the present embodiment employs an analysis formula derived from the model circuit of FIG. 3 for calculating the circuit-dependent delay variation correction table, the table may alternatively be calculated by using an analysis formula based on a different model circuit or by using a statistical method such as a Monte Carlo simulation. While Kt, which is the sum of rising transition times along the path/the sum of falling transition times along the path, and Kw, which is the sum of the wire capacitances for the nodes along the path/the sum of the MOSFET gate capacitances for the nodes along the path, are used as circuit parameters representing the characteristics of the path, Kt and Kw may alternatively be calculated by any other suitable method. For example, the circuit-dependent delay variation correction table may be produced by using the sum of falling transition times along the path/the sum of rising transition times along the path, or by using the sum of rising transition times along the path/(the sum of rising transition times+the sum of falling transition times). This similarly applies to the circuit parameter Kw.

Other circuit parameters representing the characteristics of the path may be used. While Expression 16 based on Kc, which is the delay time variation per cell due to local manufacturing variation, is used for calculating the worst value of the path delay during a manufacturing process where the in-chip local manufacturing variation is taken into consideration, any other suitable expression may be used. Alternatively, the range of delay variation per cell due to in-chip local manufacturing variation may be calculated and tabulated for each cell and for each pin by using a response surface method, a Monte Carlo simulation, or the like, so that the table can be referred to later.

### Embodiment 2

A method and apparatus for designing a semiconductor integrated circuit according to a second embodiment of the present invention will now be described with reference to the drawings.

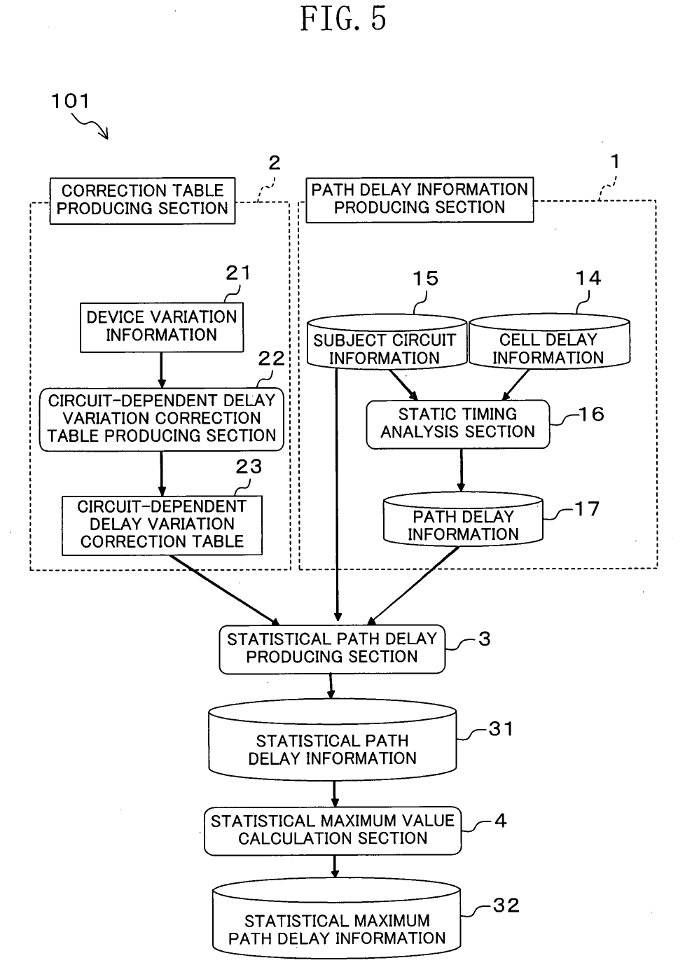

FIG. 5 is a block diagram showing the apparatus for designing a semiconductor integrated circuit of the present embodiment. In the present embodiment, like elements to those of the first embodiment shown in the block diagram of FIG. 1 will be denoted by like reference numerals and will not be further described below.

An apparatus 101 for designing a semiconductor integrated circuit of the present embodiment includes a statistical maximum value calculation section 4 and a statistical maximum path delay information 32.

The operation up to when the statistical path delay information 31 is output is similar to that of the first embodiment and will not be further described below. The statistical maximum value calculation section 4 calculates, for each path, the range of path delay variation due to in-chip local manufacturing variation based on the following expression,

$$\sqrt{{K}_{c}^{2} \frac{{\sum }_{i} ( {Tpd}_{i}^{2} )}{{( {\sum }_{i} {Tpd}_{i} )}^{2}}} \qquad expression 18$$

calculates the maximum value among the distributions, and calculates the maximum path delay distribution for the entire semiconductor integrated circuit being designed.

The maximum value among the distributions can be calculated by the method described in Non-Patent Document 3 (Anirudh Devgan, et al., “Block-Based Static Timing Analysis with Uncertainty,” IEEE International Conference on Computer-Aided design 2003), which is performed by calculating the cumulative probability density distribution of distributions and then calculating the cumulative probability density distribution after the maximum value calculation based on the product, or by any other suitable method.

With the conventional statistical static timing analysis method of Non-Patent Document 3, the calculation of the maximum value among distributions is performed for each node along the path, thereby resulting in a long calculation time. In the present embodiment, the maximum value calculation is performed after calculating the path delay distribution, whereby it is possible to shorten the amount of time required for calculation.

### Embodiment 3

A method and apparatus for designing a semiconductor integrated circuit according to a third embodiment of the present invention will now be described with reference to the drawings.

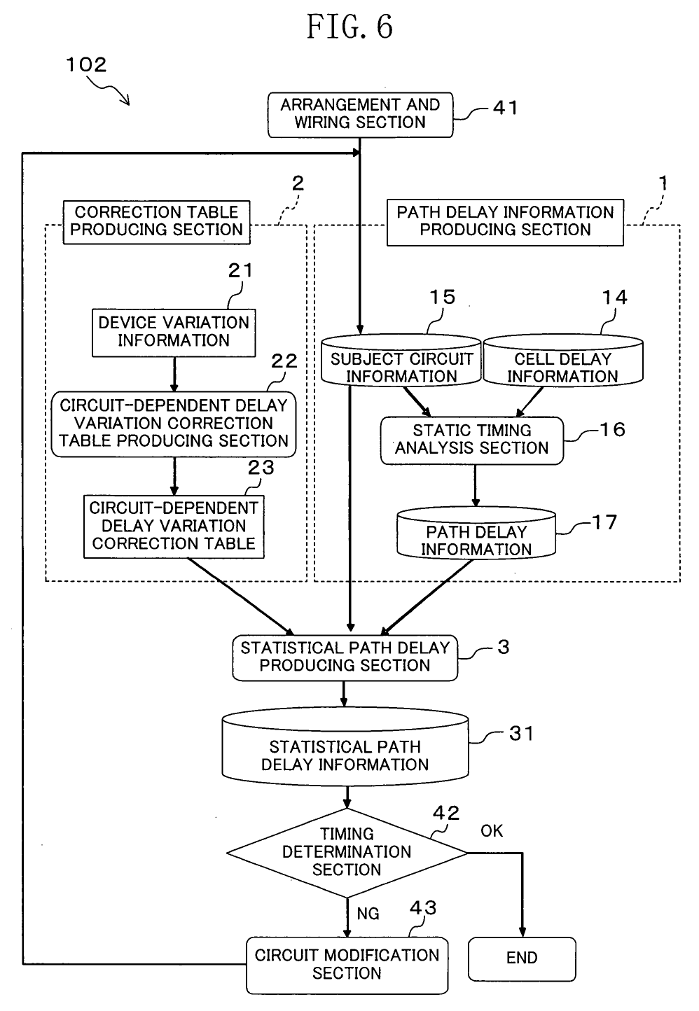

FIG. 6 is a block diagram showing the apparatus for designing a semiconductor integrated circuit of the present embodiment. In the present embodiment, like elements to those of the first embodiment shown in the block diagram of FIG. 1 will be denoted by like reference numerals and will not be further described below.

An apparatus 102 for designing a semiconductor integrated circuit of the present embodiment includes an arrangement and wiring section 41, a timing determination section 42 and a circuit modification section 43.

The arrangement and wiring section 41 reads out information on how connections are made in the semiconductor integrated circuit, and arranges and wires together cells, to thereby produce the subject circuit information 15. Based on the subject circuit information 15, the statistical path delay information 31 is output from the path delay information producing section 1, the correction table producing section 2 and the statistical path delay producing section 3. The timing determination section 42 determines whether all of the path delay times included in the statistical path delay information 31 satisfy Expression 1. The process step ends when all of the path delay times satisfy Expression 1. If the semiconductor integrated circuit requires constraints other than timing, such as the power consumption constraint, the chip area constraint, etc., the process step ends only when these conditions are all satisfied.

If there is any path that does not satisfy Expression 1, the circuit modification section 43 modifies the circuit. As described above in the first embodiment, the Kp correction value changes depending on the circuit parameters Kt and Kw. Therefore, the circuit is modified so that Kt and Kw change in such a manner that the Kp correction value is reduced. The circuit parameter Kt can be modified by, for example, changing the size of transistors included in the cell, changing the load capacitance, making a buffer circuit with two inverter circuits, etc. Similarly, the circuit parameter Kw can be modified by changing the size of the transistors or changing the load capacitance.

If a path that satisfies Expression 1 has some margin for the timing, a modification may be made so that the transistor size is decreased, whereby the power consumption or the chip area may be reduced.

As described above, with the present embodiment, as compared with the conventional static timing analysis method, it is possible to obtain a value close to the path delay worst value in an actual manufacturing process and the circuit design is modified so that the worst value satisfies the constraint, whereby it is possible to reduce the power consumption and the chip area.

### Embodiment 4

A method and apparatus for designing a semiconductor integrated circuit according to a fourth embodiment of the present invention will now be described with reference to the drawings.

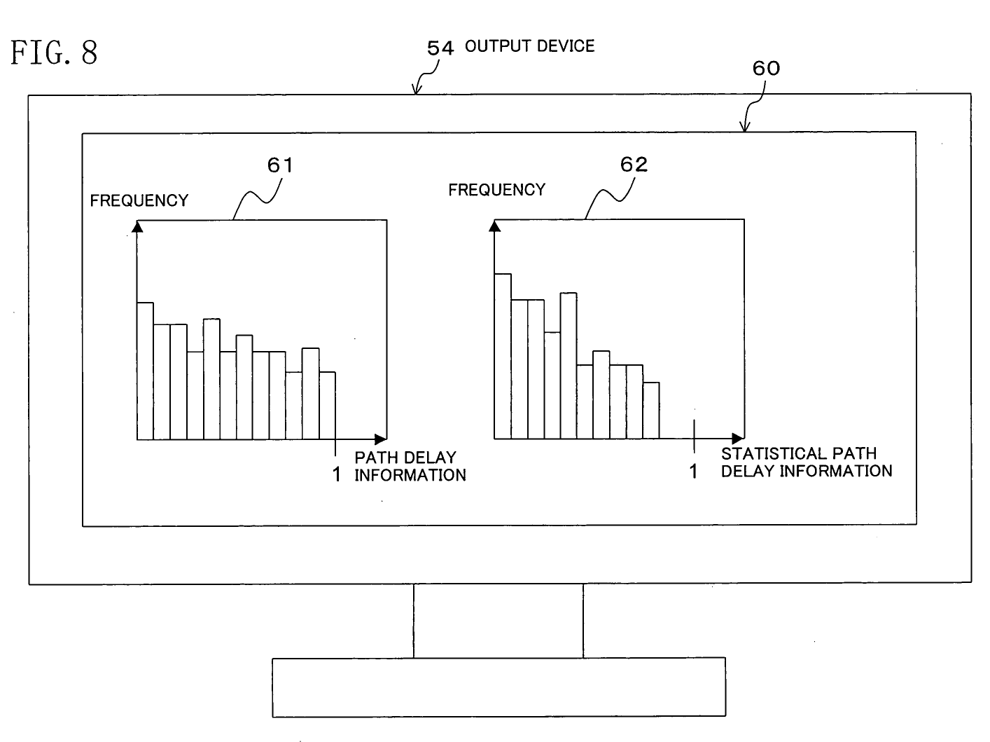

FIG. 8 shows the output device of the hardware configuration of the apparatus for designing a semiconductor integrated circuit shown in FIG. 2. In FIG. 8, reference numeral 54 denotes the output device, 60 an output screen, 61 a first graph, and 62 a second graph.

The first graph 61 is a histogram in which the horizontal axis represents the path delay information 17 and the vertical axis represents the frequency. The second graph 62 is a histogram in which the horizontal axis represents the statistical path delay information 31 and the vertical axis represents the frequency. The first graph 61 and the second graph 62 may be simultaneously output to the output screen 60 of the output device 54, or one of them may be selectively output at a time according to the input from the input device 52.

Therefore, according to the present embodiment, the user of the apparatus for designing a semiconductor integrated circuit can easily understand the difference in distribution between the path delay information 17, which is the delay value before being corrected with variation taken into consideration, and the statistical path delay information, which is the corrected delay value.

The value of the path delay information 17 and the value of the statistical path delay information 31 for the same path may be simultaneously output to the output screen 60, instead of outputting the first graph 61 and the second graph 62, whereby the user can easily understand the difference between the path delay information 17, which is the delay value before being corrected with variation taken into consideration, and the statistical path delay information, which is the corrected delay value.

### Embodiment 5

A method and apparatus for designing a semiconductor integrated circuit according to a fifth embodiment of the present invention will now be described with reference to the drawings.

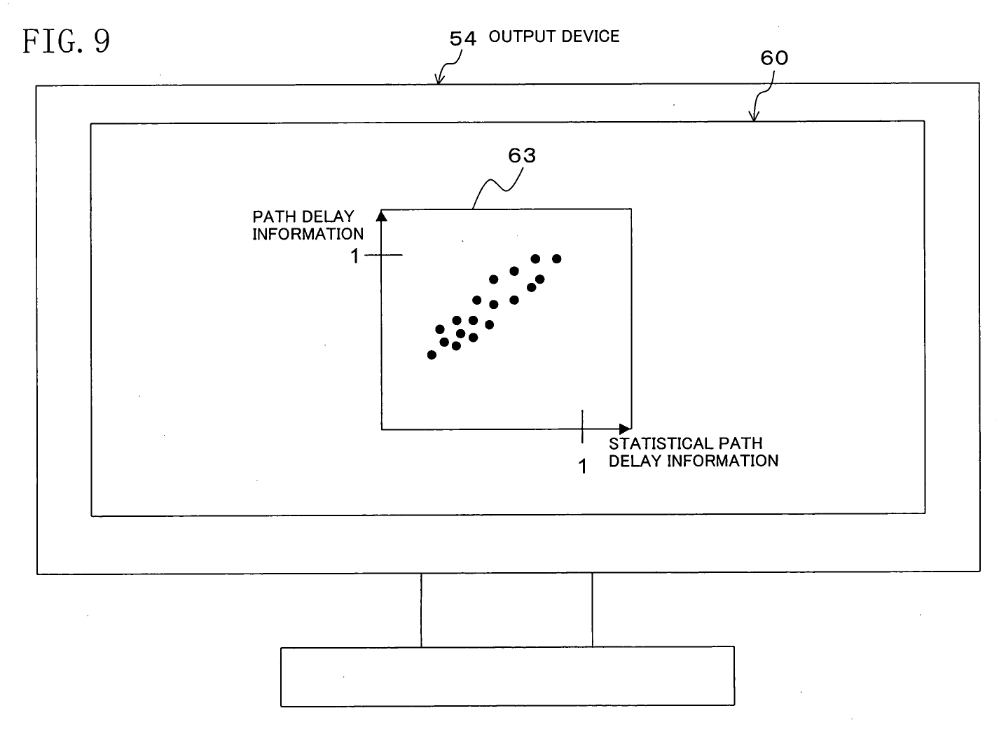

FIG. 9 shows the output device of the hardware configuration of the apparatus for designing a semiconductor integrated circuit shown in FIG. 2. In FIG. 9, reference numeral 53 denotes an output device, 60 an output screen, and 63 a third graph.

A third graph, which is a scatter diagram in which the horizontal axis represents the statistical path delay information 31 and the vertical axis represents the path delay information 17, is output to the output screen 60.

According to the present embodiment, the user of the apparatus for designing a semiconductor integrated circuit can easily understand the degree of change of the path delay information 17, which is the delay value before being corrected with variation taken into consideration, and that of the statistical path delay information, which is the corrected delay value.

If the third graph 63 is represented with the first axis representing Kt, Kw or Ld, which represents the characteristics of the circuit, and the second axis representing the path delay information or the statistical path delay information, the user of the apparatus for designing a semiconductor integrated circuit can easily understand the relationship between the parameter representing the characteristics of the circuit and the path delay information 17 or the statistical path delay information.

What is claimed is:

1. An apparatus for designing a semiconductor integrated circuit, comprising:
a path delay information producing section for producing path delay information based on delay information of a cell and subject circuit information;
a correction table producing section for receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters; and
a statistical path delay producing section for calculating each of the group of circuit parameters for a path included in the path delay information produced by the delay information producing section based on the subject circuit information and the path delay information, obtaining a delay correction value for each of the calculated group of circuit parameters with reference to the circuit-dependent delay variation correction table produced by the correction table producing section, and calculating and outputting statistical path delay information based on the obtained delay correction value and the path delay information.

2. The apparatus for designing a semiconductor integrated circuit of claim 1, wherein one of the group of circuit parameters is calculated based on a rising transition time and a falling transition time of at least each node along the path.

3. The apparatus for designing a semiconductor integrated circuit of claim 1, wherein one of the group of circuit parameters is a ratio Kt between a sum of rising transition times of nodes along the path and a sum of falling transition times of the nodes along the path.

4. The apparatus for designing a semiconductor integrated circuit of claim 1, wherein one of the group of circuit parameters is calculated based on a wire capacitance for each node along the path and a MOSFET gate capacitance for each node along the path.

5. The apparatus for designing a semiconductor integrated circuit of claim 1, wherein one of the group of circuit parameters is a ratio Kw between a sum of wire capacitances for the nodes along the path and a sum of MOSFET gate capacitances for the nodes along the path.

6. The apparatus for designing a semiconductor integrated circuit of claim 1, wherein one of the group of circuit parameters is the number of cell logic stages Ld along the path.

7. The apparatus for designing a semiconductor integrated circuit of claim 1, wherein one of the group of circuit parameters is the number of paths for which a delay value is within a predetermined range.

8. The apparatus for designing a semiconductor integrated circuit of claim 1, wherein one of the device variation information is variation information of transistor saturation current value.

9. The apparatus for designing a semiconductor integrated circuit of claim 8, wherein the device variation information of the transistor saturation current value includes a median value Idsn_TYP and a standard deviation σ_IN of a saturation current value of an N-type MOS transistor, a median value Idsp_TYP and a standard deviation σ_IP of a saturation current value of a P-type MOS transistor, and a correlation coefficient R_PN between the saturation current value of the N-type MOS transistor and the saturation current value of the P-type MOS transistor.

10. The apparatus for designing a semiconductor integrated circuit of claim 1, wherein one of the device variation information is variation information of a capacitance value of a gate terminal of a transistor.

11. The apparatus for designing a semiconductor integrated circuit of claim 1, wherein one of the device variation information is variation information of a capacitance value of a source or drain terminal of a transistor.

12. The apparatus for designing a semiconductor integrated circuit of claim 1, wherein one of the device variation information is variation information of a capacitance value of an element other than a transistor.

13. The apparatus for designing a semiconductor integrated circuit of claim 12, wherein the device variation information of the capacitance value of an element other than a transistor is a value derived from variation in a thickness, width or height of a metal wire.

14. The apparatus for designing a semiconductor integrated circuit of claim 1, wherein the correction table producing section calculates the delay correction value depending on the circuit parameter by using an analysis formula representing a relationship between the circuit parameter and the delay correction value.

15. The apparatus for designing a semiconductor integrated circuit of claim 1 wherein the correction table producing section calculates:
a variable idsp dependent on Idsp_TYP and σ_IP;
a variation variable idsn dependent on Idsn_TYP, σ_IN, R_PN and the variable idsp;
variables cg1 and cg2 dependent on a capacitance variation of a gate, a source of a drain of the transistor; and
a path delay Tpd dependent on the variables cw1 and cw2 dependent on variation information of a capacitor other than the transistor.

16. The apparatus for designing a semiconductor integrated circuit of claim 15, wherein the path delay Tpd is also dependent on the ratio Kt and the ratio Kw, and is defined by an expression including the following expression:
Kt(cg1+Kw·cw1)/idsp+(cg2+Kw·cw2)/idsn, or
(cg1+Kw·cw1)/idsp+Kt(cg2+Kw·cw2)/idsn, or
Kt(Kw·cg1+cw1)/idsp+(Kw·cg2+cw2)/idsn, or
(Kw·cg1+cw1)/idsp+Kt(Kw·cg2+cw2)/idsn.

17. The apparatus for designing a semiconductor integrated circuit of claim 15, wherein a ratio Tpd_worst1/Tpd_worst2 is produced as a value of the table at least for each combination of values of the circuit parameters Kt and Kw, wherein Tpd_worst1 is obtained by multiplying a standard deviation of the path delay Tpd by a first constant value and adding a median value of the path delay Tpd to the product, and Tpd_worst2 is a value obtained by substituting the variables cg1, cw1, idsp, cg2, cw2 and idsn in the path delay expression with second to seventh constant values, respectively.

18. The apparatus for designing a semiconductor integrated circuit of claim 1, wherein the cell delay information includes at least one of a transition time of an internal node of each cell and a wire capacitance and gate capacitance of an internal node of each cell.

19. The apparatus for designing a semiconductor integrated circuit of claim 1, wherein a transition time of an internal node of each cell is calculated based on an input waveform transition time, an output waveform transition time and a propagation delay time added to the cell.

20. The apparatus for designing a semiconductor integrated circuit of claim 1, wherein a wire capacitance and a gate capacitance of an internal node of each cell are calculated based on a size of an output transistor of the cell.

21. The apparatus for designing a semiconductor integrated circuit of claim 1, wherein a subject circuit is modified so that at least one of Kw, Kt and Ld is changed in such a manner that the calculated statistical path delay information is within a predetermined range.

22. The apparatus for designing a semiconductor integrated circuit of claim 21, wherein a change in at least one of Kw and Kt is made by changing a size of a transistor included in the path.

23. The apparatus for designing a semiconductor integrated circuit of claim 21, wherein a change in at least one of Kw and Kt is made by inserting a third logic element between a first logic element present along the path and a second logic element whose input is connected to an output of the first logic element.

24. The apparatus for designing a semiconductor integrated circuit of claim 23, wherein the third logic element is a buffer circuit or an inverter circuit.

25. An apparatus for designing a semiconductor integrated circuit, comprising:
a transition time ratio calculating section for calculating a ratio Kt between a sum of rising transition times of nodes along a first path and a sum of falling transition times of the nodes along the first path, based on subject circuit information and path delay information;
a capacitance ratio calculating section for calculating a ratio Kw between a sum of wire capacitances for the nodes along the first path and a sum of MOSFET gate capacitances for the nodes along the first path, based on the subject circuit information and the path delay information; and
a statistical path delay information calculating section for calculating and outputting statistical path delay information dependent on the delay time of the first path included in the path delay information and at least one of Kt and Kw.

26. A method for designing a semiconductor integrated circuit, comprising:
a path delay information producing step of producing path delay information based on delay information of a cell and subject circuit information;
a correction table producing step of receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters; and
a statistical path delay producing step of calculating each of the group of circuit parameters for a path included in the path delay information produced in the delay information producing step based on the subject circuit information and the path delay information, obtaining a delay correction value for each of the calculated group of circuit parameters with reference to the circuit-dependent delay variation correction table produced in the correction table producing step, and calculating and outputting statistical path delay information based on the obtained delay correction value and the path delay information.

27. The method for designing a semiconductor integrated circuit of claim 26, wherein one of the group of circuit parameters is calculated based on a rising transition time and a falling transition time of at least each node along the path.

28. The method for designing a semiconductor integrated circuit of claim 26, wherein one of the group of circuit parameters is a ratio Kt between a sum of rising transition times of nodes along the path and a sum of falling transition times of the nodes along the path.

29. The method for designing a semiconductor integrated circuit of claim 26, wherein one of the group of circuit parameters is calculated based on a wire capacitance for each node along the path and a MOSFET gate capacitance for each node along the path.

30. The method for designing a semiconductor integrated circuit of claim 26, wherein one of the group of circuit parameters is a ratio Kw between a sum of wire capacitances for the nodes along the path and a sum of MOSFET gate capacitances for the nodes along the path.

31. The method for designing a semiconductor integrated circuit of claim 26, wherein one of the group of circuit parameters is the number of cell logic stages Ld along the path.

32. The method for designing a semiconductor integrated circuit of claim 26, wherein one of the group of circuit parameters is the number of paths for which a delay value is within a predetermined range.

33. The method for designing a semiconductor integrated circuit of claim 26, wherein one of the device variation information is variation information of transistor saturation current value.

34. The method for designing a semiconductor integrated circuit of claim 33, wherein the device variation information of the transistor saturation current value includes a median value Idsn_TYP and a standard deviation σ_IN of a saturation current value of an N-type MOS transistor, a median value Idsp_TYP and a standard deviation σ_IP of a saturation current value of a P-type MOS transistor, and a correlation coefficient R_PN between the saturation current value of the N-type MOS transistor and the saturation current value of the P-type MOS transistor.

35. The method for designing a semiconductor integrated circuit of claim 26, wherein one of the device variation information is variation information of a capacitance value of a gate terminal of a transistor.

36. The method for designing a semiconductor integrated circuit of claim 26, wherein one of the device variation information is variation information of a capacitance value of a source or drain terminal of a transistor.

37. The method for designing a semiconductor integrated circuit of claim 26, wherein one of the device variation information is variation information of a capacitance value of an element other than a transistor.

38. The method for designing a semiconductor integrated circuit of claim 37, wherein the device variation information of the capacitance value of an element other than a transistor is a value derived from variation in a thickness, width or height of a metal wire.

39. The method for designing a semiconductor integrated circuit of claim 26, wherein the correction table producing step calculates the delay correction value depending on the circuit parameter by using an analysis formula representing a relationship between the circuit parameter and the delay correction value.

40. The method for designing a semiconductor integrated circuit of claim 26, wherein the correction table producing step calculates:
a variable idsp dependent on Idsp_TYP and σ_IP;
a variation variable idsn dependent on Idsn_TYP, σ_IN, R_PN and the variable idsp;
variables cg1 and cg2 dependent on a capacitance variation of a gate, a source of a drain of the transistor; and
a path delay Tpd dependent on the variables cw1 and cw2 dependent on variation information of a capacitor other than the transistor.

41. The method for designing a semiconductor integrated circuit of claim 40, wherein the path delay Tpd is also dependent on the ratio Kt and the ratio Kw, and is defined by an expression including the following expression:
Kt(cg1+Kw·cw1)/idsp+(cg2+Kw·cw2)/idsn, or
(cg1+Kw·cw1)/idsp+Kt(cg2+Kw·cw2)/idsn, or
Kt(Kw·cg1+cw1)/idsp+(Kw·cg2+cw2)/idsn, or
(Kw·cg1+cw1)/idsp+Kt(Kw·cg2+cw2)/idsn.

42. The method for designing a semiconductor integrated circuit of claim 40, wherein a ratio Tpd_worst1/Tpd_worst2 is produced as a value of the table at least for each combination of values of the circuit parameters Kt and Kw, wherein Tpd_worst1 is obtained by multiplying a standard deviation of the path delay Tpd by a first constant value and adding a median value of the path delay Tpd to the product, and Tpd_worst2 is a value obtained by substituting the variables cg1, cw1, idsp, cg2, cw2 and idsn in the path delay expression with second to seventh constant values, respectively.

43. The method for designing a semiconductor integrated circuit of claim 26, wherein the cell delay information includes at least one of a transition time of an internal node of each cell and a wire capacitance and gate capacitance of an internal node of each cell.

44. The method for designing a semiconductor integrated circuit of claim 26, wherein a transition time of an internal node of each cell is calculated based on an input waveform transition time, an output waveform transition time and a propagation delay time added to the cell.

45. The method for designing a semiconductor integrated circuit of claim 26, wherein a wire capacitance and a gate capacitance of an internal node of each cell are calculated based on a size of an output transistor of the cell.

46. The method for designing a semiconductor integrated circuit of claim 26, wherein a subject circuit is modified so that at least one of Kw, Kt and Ld is changed in such a manner that the calculated statistical path delay information is within a predetermined range.

47. The method for designing a semiconductor integrated circuit of claim 46, wherein a change in at least one of Kw and Kt is made by changing a size of a transistor included in the path.

48. The method for designing a semiconductor integrated circuit of claim 46, wherein a change in at least one of Kw and Kt is made by inserting a third logic element between a first logic element present along the path and a second logic element whose input is connected to an output of the first logic element.

49. The method for designing a semiconductor integrated circuit of claim 48, wherein the third logic element is a buffer circuit or an inverter circuit.

50. A method for designing a semiconductor integrated circuit, comprising:
a transition time ratio calculating step of calculating a ratio Kt between a sum of rising transition times of nodes along a first path and a sum of falling transition times of the nodes along the first path, based on subject circuit information and path delay information;
a capacitance ratio calculating step of calculating a ratio Kw between a sum of wire capacitances for the nodes along the first path and a sum of MOSFET gate capacitances for the nodes along the first path, based on the subject circuit information and the path delay information; and
a statistical path delay information calculating step of calculating and outputting statistical path delay information dependent on the delay time of the first path included in the path delay information and at least one of Kt and Kw.

51. A method for designing a semiconductor integrated circuit, comprising:
a path delay information producing step of producing path delay information based on delay information of a cell and subject circuit information;
a correction table producing step of receiving device variation information and calculating a delay correction value for each combination of values of a group of circuit parameters based on the device variation information to thereby produce a circuit-dependent delay variation correction table in which each delay correction value is associated with the corresponding combination of values of the group of circuit parameters;
a statistical path delay producing step of calculating each of the group of circuit parameters for a path included in the path delay information produced in the delay information producing step based on the subject circuit information and the path delay information, obtaining a delay correction value for each of the calculated group of circuit parameters with reference to the circuit-dependent delay variation correction table produced in the correction table producing step, and calculating and outputting statistical path delay information based on the obtained delay correction value and the path delay information; and
an output step of producing a value or a graph based on the statistical path delay information and the path delay information to output the produced value or graph to an output device.

52. The method for designing a semiconductor integrated circuit of claim 51, wherein the value or graph produced in the output step based on the statistical path delay information and the path delay information includes a first graph obtained by processing the path delay information and a second graph obtained by processing the statistical path delay information.

53. The method for designing a semiconductor integrated circuit of claim 52, wherein in the output step, one of the first graph and the second graph is selectively output at a time to the output device according to an input from an input device.

54. The method for designing a semiconductor integrated circuit of claim 51, wherein the output step produces a third graph including at least one of information obtained by processing at least the path delay information and information obtained by processing at least the statistical path delay information to output the third graph to the output device.

55. The method for designing a semiconductor integrated circuit of claim 54, wherein the third graph produced in the output step further includes information obtained by processing Kt, Kw or Ld.

56. The method for designing a semiconductor integrated circuit of claim 52, wherein the first or second graph is a histogram.

57. The method for designing a semiconductor integrated circuit of claim 52, wherein the first or second graph is a scatter diagram.
